(19) United States
(12) Patent Application Publication
(10) Pub. No.: US 2023/0412400 A1
(43) Pub. Date: Dec. 21, 2023

(54) METHOD FOR SUSPENDING PROTECTION OF AN OBJECT ACHIEVED BY A PROTECTION DEVICE

(71) Applicant: RIDDLE & CODE GMBH, Wien (AT)

(72) Inventor: Thomas FÜRSTNER, Malta (AT)

(21) Appl. No.: 18/252,352

(22) PCT Filed: Nov. 9, 2021
(86) PCT No.: PCT/AT2021/060423

§ 371 Date: May 9, 2023

(30) Foreign Application Priority Data
Nov. 9, 2020 (AT) A 50962/2020

(51) Int. Cl. H04L 9/32; H04L 9/30

(52) U.S. Cl. CPC H04L 9/3271; H04L 9/30; H04L 9/3228

(57) ABSTRACT

The disclosure concerns a method for suspending protection of an object achieved by a protection device, comprising the following steps:
a first data connection is established between the protection device and a mobile device;
a second data connection is established between the protection device and a transaction directory;
the protection device receives via the first data connection a public key;
the protection device requests via the second data connection a search of transactions associated with the public key within the transaction directory;
the protection device determines that the search within the transaction directory yields at least one transaction associated with the public key;
a third data connection is established between the protection device and an authentication entity;
the protection device receives via the first data connection an identification string;
the protection device requires via the third data connection a clearance of the identification string by the authentication entity;
the protection device determines that the identification string is cleared;
based on a determination that the search within the transaction directory yields at least one transaction and based on a determination that the identification string is cleared, the protection device suspends protection of the object

The present disclosure relates to a method for suspending a protection of an object achieved by a protection device, in particular for suspending a physical protection of an object achieved by a protection device. Generally, the protection to be suspended may be achieved mechanically, electrically or magnetically.

When the suspension of the physical protection of an object is requested by a requesting entity, the protection device should verify the requesting entity's identity and the requesting entity's authorization of accessing the object. The protection device will subsequently suspend the protection of the objection based on these determinations.

EP 3258660 A1 shows a method for suspending a physical protection of an object with a protection device, a dongle, a host device and a public transaction directory. The host device authenticates the protection device using a first public key and the dongle using a second public key. The host device searches for a transaction associated with the first public key and the second public key within the public transaction directory. Based on these authentications, physical protection of the object is suspended.

However, this method requires the use of a dongle. Furthermore, a perpetrator that manages to come into possession of the second public key and a private key associated with the second public key will be able to gain access to the object. Furthermore, the process is based on the involvement of a predetermined third party on placing the transaction in the public directory and, therefore, at least some information about the transaction has to be known to the third party.

US 2016/0162897 A1 shows a method for user authentication using cryptocurrency transactions as access code. A computing device receives from a data storage device associated with a first entity authentication information demonstrating possession of a private key. The computing device retrieves from an audit chain at least one cryptocurrency transaction to an address associated with a public key corresponding to the private key. The computing device authenticates the first entity based on the retrieved cryptocurrency transaction.

Similarly, U.S. Pat. No. 10,333,706 B2 shows a method for authorising a transaction. It is determined with a cryptographic challenge if a user possesses the private key associated with a public key. Subsequently, an attestation address is derived using the public key and the existence of an attestation transaction at the attestation address in a centralized or distributed ledger is determined. Upon verification of the existence of the attestation transaction, a purchase transaction is completed.

However, information about the private and public key may be maliciously extracted from the person or device possessing this authentication information and the token can be stolen. It is a disadvantage of the method of the prior art that mere possession of the private and public key and if applicable access to the token will allow anyone to authenticate themselves as the original owner of this information.

Furthermore, within the framework of the prior art, the only way of invalidating an access right granted by a transaction placed in a public directory may be to place a further transaction repealing the earlier access right. However, conducting a transaction in a public ledger may take some time to be accomplished, e.g. due to the consensus mechanisms in distributed ledgers. For instance, Bitcoin transaction times can take anywhere from a few minutes to over one day. Therefore, within the framework of the prior art it is not possible to immediately invalidate access rights granted by a transaction placed in the public directory.

Also, to prevent anybody from being able to place a transaction constituting a smart contract in the transaction directory, the prior art relies on the relevant transaction to be signed by a trusted authority and the protection device to be able to verify the signature of the trusted authority. Thus, transactions and therefore smart contracts can only be placed in the transaction directory under involvement of the trusted authority. However, it can be desirable to grant access rights independently of the knowledge or involvement of such a trusted authority.

Furthermore, the method of the prior art relies completely on the integrity and unforgeability of the transactions of the accessed audit chain. If a perpetrator manages to manipulate the audit chain or register a false transaction, they can gain arbitrary access.

The article “Blockchains and Smart Contracts for the Internet of Things” by Christidis et al (in: IEEE Access, Vol. 4, 10. Mai 2016, pages 2292-2303) describes—after a general introduction to blockchains—their use in IoT. An example for sharing services and properties is described. It works on smart electronic locks (“Slocks”) that can be unlocked with a device that carries the appropriate token. These tokens are bought on the Ethereum blockchain, a public blockchain network optimized for smart contracts that uses its own cryptocurrency, called Ether. The owner of a Slock who wishes to rent their house or car sets a price for timed access to that electronic door lock. An interested party can use a mobile app to identify the Slock, pay the requested amount in Ethers, then communicate with the lock via a properly signed message (using the Whisper peer-to-peer communication protocol) to unlock it. Billing is simplified by having all the Slocks operating on the same blockchain. However, there is no means to authenticate the participants in this system.

US 2016/277412 A1 concerns a secure authorization of electronic transactions and/or a right of entry to access secure locations through a matching function of regenerated specified distinctive identifiers drawn from a local/mobile computing device to those specified distinctive identifiers previously registered in a validation database, in order to validate the identity of the local/mobile computing device.

WO 2017/195160 A1 concerns a method for verifying the integrity of a digital asset, in particular a computer software to be installed, using a distributed hash table and a peer-to-peer distributed ledger, e.g. the Bitcoin blockchain.

U.S. Pat. No. 9,858,781 B1 concerns the identity validation in an access system, e.g. the authentication that the person holding an access card is the person that was actually assigned that card. The proposed architecture employs Blockchain technology that allows an access reader to validate information (a token) presented via the identity card, which token is relevant to the identity of the card holder.

US 2018/117447 A1 concerns an IoT device, wherein Blockchain smart contracts can be used to facilitate secure operation. The wealth of data generated by IoT devices shall be handled and fraudulent and harmful activities arising from hacked IoT devices shall be mitigated. A device unit has an address, which is identified in a distributed ledger with the address. Tamperproof events are stored on the distributed ledger and terms of a smart contract in the ledger generated by another machine are executed.

It is an objective of the present invention to lessen or alleviate one or more problems of the prior art. In particular, it is an objective of the present invention to provide a method for suspending a (physical) protection of an object which is more secure and/or wherein access rights can be granted without the involvement or knowledge of a predetermined third party. Furthermore, it should optionally be possible to invalidate previously granted access rights quickly.

This is achieved by a method for suspending physical protection of an object achieved by a protection device, comprising at least the following steps:
a first data connection is established between the protection device and a mobile device;
a second data connection is established between the protection device and a transaction directory;
the protection device receives via the first data connection a public key;
the protection device requests via the second data connection a search of transactions associated with the public key within the transaction directory;
the protection device determines that the search within the transaction directory yields at least one transaction associated with the public key;
a third data connection is established between the protection device and an authentication entity;
the protection device receives via the first data connection an identification string;
the protection device requires via the third data connection a clearance of the identification string by the authentication entity;
the protection device determines that the identification string is cleared;
based on a determination that the search within the transaction directory yields at least one transaction and based on a determination that the identification string is cleared, the protection device suspends protection of the object.

Thus, access rights to the object can be managed by registering/placing a transaction in a transaction directory, which does not require the involvement of a trusted authority. This allows a high degree of flexibility, and, if required, anonymity, in managing the access rights. At the same time, suspending protection of the object is not only dependent on the determination of a registration of such a transaction associated with the public key of the mobile device, but is further secured by obtaining a clearance from the authentication entity. Still, the authentication entity does not need to be passed complete (or even any) information about the ongoing process of authorizing the suspension of the protection of the object as requested by the mobile device. The authentication entity may be different from the transaction directory and from the mobile device. The protection suspended is optionally a physical protection.

For example, this method can be used for protection against a theft of the public key, or—as is more relevant for practical applications—of a private key cryptographically associated with the public key. Thus, as long as no theft or loss of any keys is reported, the authorization entity may clear the identification string without any further knowledge about the process of the suspension of protection of the object as requested by the mobile device. Only if a theft or loss has been reported, the identification string may be requested to contain additional information to allow prevention of an abuse of a stolen key. The same is possible concerning the use of a security token in the process of suspension of protection and in case of a stolen security token. In a similar way, the present disclosure allows to prevent access to the object, in case a manipulation of the transaction directory or the placement of a fraudulent transaction in the transaction directory become known. Additionally, the authorization entity can ensure that invalidations or amendments to an access right as determined by a transaction in the transaction directory cannot be misused during the time span it takes to register such an invalidation or amendment transaction in the transaction directory. In order to determine if the identification string should be cleared, the authentication entity may comprise a database of registered mobile devices or mobile device identifiers or addresses and in particular one or more identification string associated therewith. The authentication entity may further comprise a revocation list of public keys (or equivalent identifiers) and/or of identification strings, which are not to be cleared. If an identification string is not cleared by the authentication entity, protection may not be suspended by the protection device.

The transaction directory is optionally a public transaction directory or a private transaction directory. Optionally, the transaction directory acts as a write-once storage, meaning that it is protected against modification and deletion of transactions. However, transactions may be superseded by later transactions “consuming” earlier transactions, wherein the later transaction is only valid if it is cleared by parties (beneficiaries) authorized by the consumed earlier transaction. Optionally, transactions in the transaction directory are linked using cryptography. Optionally, transactions in the transaction directory can have at least one input address and at least one output address. Optionally, transactions may comprise a digital signature. Said digital signature may be generated with one or more private keys cryptographically associated with the one or more input addresses. Acceptance of a transaction with a certain input address in the transaction directory can be dependent on the knowledge of a private key cryptographically associated with a public key, wherein an association of the public key with the certain input address can be verified. A search of transactions associated with the public key within the transaction directory means that the transaction directory is queried for transactions that comprise the public key or that comprise an address associated with or representative of the public key.

The mobile device is for example a smartphone, tablet or personal computer. The protection device may comprise a flex ray board and/or a microcontroller unit, in particular a hardened automotive microcontroller unit. The method of the present disclosure is optionally used for object sharing, in particular car sharing. The authentication entity may be a server, e.g. operating a database, e.g. a relational database.

For determining by the protection device that the identification string is cleared, the protection device can receive a clearance message from the authentication entity. The request of the protection device for clearance of the identification string optionally comprises an indication of the identification string. The protection suspended is optionally a physical protection, for example a mechanical protection. Suspending protection of the object may comprise controlling an actuator to suspend protection of the object. The object can be a car; in which case suspending protection of the car can comprise unlocking a car's door and/or unlocking an immobiliser and/or an ignition interlock of the car (in which later case the suspended physical protection would be an electrical protection).

The identification string may be attributable by the authentication entity to the pending authorization process, in particular to the mobile device and/or the protection device. In particular, the identification string may comprise information about the pending authorization process, the mobile device and/or the protection device. The authentication may include a check by the authentication entity in a database, in particular a search in the database. The database could comprise information about (recently) revoked access rights.

Optionally, the method further comprises:
the protection device determines for the public key a standing access right associated with an object address, which object address (is associated with the object and) is stored in an internal memory of the protection device;
the protection device suspends protection of the object further based on a determination for the public key of the standing access right associated with the object address. Optionally, the standing access right is determined from the transaction associated with the public key. This can comprise determining that the object address is an input address of said transaction and/or the output address of said transaction is associated with the public key. It may also include determining that the transaction associated with the object address is linked to another transaction associated with the public key.

For determining for the public key the standing access right associated with the object address, the method and in particular the step of requesting by the protection device via the second data connection a search of transactions associated with the public key within the transaction directory comprises:
the protection device requests via the second data connection a search of transactions associated with the object address. Optionally, the object address is one of the input addresses of the transaction. Optionally, the object address is associated with an object public key, which is cryptographically associated with an object private key. I.e., knowledge of the object private key is necessary for placing a transaction with an input address, which input address is associated with the object address. Thereby, an access right can only be granted upon knowledge of the object private key. This object private key can be known to an administration entity (e.g. a manufacturer of the object or a person installing the protection device). Thus, the administration entity registers a transaction in the transaction directory, wherein an input address of the transaction is associated with the object address and, optionally, an output address of the transaction is associated with an address of a receiving entity of the access right to the object. Optionally, the protection device requests via the second data connection a search of transactions associated with both, the object address as well as the public key.

Cryptographically associated keys or “key pairs” are commonly used in asymmetric cryptography (public-key cryptography). The cryptographic association between a public key and a private key is expressed by the fact that a message (i.e. information) encrypted using the public key can only be decrypted using the respective associated private key and vice versa. Therein, typically, the public key can be derived from the private key, but not the other way around. Placing a (valid) transaction in the distributed directory with a certain input address associated with a certain public key may require knowledge of a certain private key cryptographically associated with the certain public key.

Optionally, determining for the public key the standing access right associated with the object address further comprises:
the protection device determines a last object transaction, which last object transaction is the chronologically last transaction associated with the object address. Thereby, previous access rights granted by performing a chronologically previous transaction associated with the object address can be declared outdated and obsolete and optionally superseded by a different access right (e.g. an access right of a different entity). Optionally, the protection device may receive via the first data connection a transaction provided by the mobile device as a candidate for the last object transaction. In this instance, the protection device may request via the second data connection a search of transactions succeeding the candidate transaction and associated with the public key and/or the object address to confirm whether the candidate transaction is indeed the last transaction to determined the access rights.

Optionally, determining for the public key the standing access right associated with the object address further comprises:
the protection device requests via the second data connection a search of a chain of transactions, wherein each subsequent transaction in the chain of transactions is linked to a respective previous transaction in the chain of transactions by at least one output address of the previous transaction being identical to at least one input address of the subsequent transaction, wherein the subsequent transaction is chronologically after the respective previous transaction and wherein a first transaction in the chain of transactions is the last object transaction;
the protection device determines that the chain of transactions comprises at least one transaction associated with the public key;
the protection device determines for the public key the standing access right associated with the object address based on a determination that the chain of transactions comprises at least one transaction comprising at least one output address associated with the public key. Optionally, the determination can be based on an output address of the last transaction in the chain of transactions being associated with the public key. Optionally, the first transaction in the chain of transactions is the last object transaction. Optionally, each transaction in the chain of transactions is the chronologically last transaction from comprising that input address. Thus, access rights can be revoked at each level in the chain of transactions. Basing the determination on this chain of transactions allows providing an access right to one or more intermediate entities, which subsequently may grant access rights to further entities. For example, the object's owner (e.g. a car rental company) may grant an access right to an intermediate entity (e.g. a company) by placing a transaction from the object address (e.g. car address) to a company's address. Subsequently, the intermediate entity may forward the access right to a user (e.g. an employee of the company) or to multiple users by placing a transaction from the company's address to one or more addresses associated with the public key (of the user). The transactions may be configured such that an access right may be revoked by the object's owner by placing a later transaction from the object address (e.g. back to the object address, in case no access right to the object shall at that time be granted). This would be possible, if the object owner can sign a valid transaction from any assigned address to itself (e.g. using a 1-of-2 multisignature setup) or if there is no limit on outgoing transactions such that simply only the chronologically last outgoing transaction from any given address is valid. The access right may similarly also be revocable or revoked by the intermediate entity (entities).

Optionally, determining for the public key the standing access right associated with the object address further comprises:
the protection device determines a last output transaction in the chain of transaction, which last output transaction is the chronologically last transaction in the chain of transactions comprising at least one output address associated with the public key;
the protection device determines for the public key the standing access right associated with the object address further based on a determination that there is no later input transaction, which later input transaction is chronologically after the last output transaction and which later input transaction comprises at least one input address associated with the public key. Thus, access rights can also be returned or passed on from an address associated with the public key.

Optionally, the method further comprises:
the protection device authenticates the mobile device using the public key;
the protection device suspends protection of the object further based on successful authentication of the mobile device. In particular, the protection device can use the public key to determine if the mobile device is in possession of a private key cryptographically associated with the public key and, therefore, if the mobile device is the actual device which the access right shall be granted to.

In order to determine if a given protection device is authentic, it may be verified whether it is indeed in possession and control of the first private key. Optionally, authenticating the mobile device by the protection device comprises:
the protection device sends a random challenge to the mobile device via the first data connection;
the protection device receives a signature of the random challenge signed using a private key cryptographically associated with the public key via the first data connection;
the protection device verifies the signature with the public key;
based on a determination that verification succeeds, the protection device authenticates the mobile device. Optionally, the method comprises:
the mobile device signs the random challenge using a private key cryptographically associated with the public key and stored in an internal memory of the mobile device; and/or
the mobile device sends the signature of the random challenge to the protection device via the first data connection. Since the content of the random challenge is unknown in advance, the mobile device can only produce a valid signature of the random challenge after its generation and only if it is in possession of the private key between the generation of the random challenge and the answer to the protection device.

Optionally, the method further comprises:
based on an authentication request, the mobile device receives the identification string from the authentication entity via a fourth data connection established between the mobile device and the authentication entity. The identification string can be previously generated by the authentication device. In order to determine, how to transmit a requested identification string to the mobile device, the authentication entity may comprise a database of registered mobile devices or mobile device identifiers or addresses, wherein each mobile device record is associated with a public key in order to map a public key received from the protection device to a mobile device. The authentication entity may further comprise a revocation list of public keys (or equivalent identifiers), which are not to be served with an identification string.

Optionally, the identification string is a one time password. Optionally, the authentication device generates the identification string on receiving an authentication request. Generating the identification string may take into account information about the public key, in particular the identification string may comprise the public key or a hash of the public key.

Optionally, the one time password is unique for the authentication request. I.e., the identification string is unique to one attempt of authorizing the protection device and/or is only valid during one attempt of authorizing the protection device. Thus, the security of the authentication process can be increased.

Optionally, the authentication request comprises:
the protection device requires via the third data connection the authentication entity to send the identification string to the mobile device via the fourth data connection. Thereby, the protection device can also transmit data descriptive of the pending authentication process to the authentication entity, which the authentication entity may take into account on generating the identification string.

Optionally, the authentication request comprises:
the mobile device requires via the fourth data connection the authentication entity to send the identification string to the mobile device via the fourth data connection. It can be required for the mobile device to identify itself for the authentication entity, in particular it can be required for the mobile device to log in with the authentication entity. Thus, for example, the authentication entity can confirm the identity and legitimacy of the mobile device, whereas the details about the ongoing process of achieving access to the object do not need to be known or transmitted to the authentication entity.

Optionally, the request to the authentication entity to send the identification string to the mobile device comprises an indication of the public key. The authentication entity may check the mobile device's possession of the corresponding private key with a challenge, as described in the context of the mobile device and the protection device.

Optionally, the method comprises:
the protection device determines that the transaction associated with the public key comprises a contract script, which evaluates at least one condition for unlocking the protection device;
the protection device executes the contract script;
the protection device determines that the contract script executes successfully and the at least one condition of the contract script is fulfilled;
the protection device suspends protection of the object further based on the determination that the contract script executes successfully. Thus, the suspension of protection can be based on the presence of certain further conditions.

Optionally, executing the contract script comprises:
determining a current time;
determining that the current time is within at least one time interval defined in the contract script. Thus, access rights can be granted for certain times only.

Optionally, the method comprises:
the protection device requires a report transaction to be registered within the transaction directory, wherein the report transaction comprises an indication of a suspension of the physical protection of the object. In particular, the method may further comprise requesting (in particular by the protection device) the registration of a transaction (“commencement transaction”) in the transaction directory indicative of the commencement of the suspension of protection by the protection device, which commencement transaction is optionally associated with the object address. Furthermore, in particular, the method may further comprise requesting (in particular by the protection device) the registration of a transaction (“termination transaction”) in the transaction directory indicative of a termination of the suspension of protection of the object by the protection device, which termination transaction is optionally associated with the object address. The report transaction and/or the commencement transaction and/or the termination transaction may comprise information indicative of the object and/or at least one attribute of the object, of the mobile device and/or a mobile device's user, and/or of the protection device. The attribute of the object may be an insurance status of the object, a fuel/energy level of the object and/or a service and maintenance status of the object.

Optionally, the method further comprises:
the protection device determines at least one physical status parameter of the object by at least one sensor of the object and/or the protection device;
wherein the report transaction further comprises an indication of the at least one physical status parameter of the object and/or the protection device.

Optionally, the transaction directory is a distributed directory, in particular a distributed public directory, optionally a block chain, further optionally the bitcoin blockchain. Thus, the transaction in the transaction directory is stored publicly available and/or in a fraud resistant way.

Optionally, the first data connection is a wireless data connection, optionally a Bluetooth connection or a near field communication (NFC) connection. Thus, the protection device can also check the physical presence of the mobile device.

Furthermore, this disclosure concerns a protection device configured to conduct the method according to any of the variants described herein. Additionally, this disclosure concerns a system comprising a protection device and a mobile device, the system configured to conduct the method according to any of the variants described herein. Further, this disclosure concerns a system comprising a protection device and an authentication entity, the system configured to conduct the method according to any of the variants described herein.

By way of example, the disclosure is further explained with respect to some selected embodiments shown in the drawings. However, these embodiments shall not be considered limiting for the disclosure.

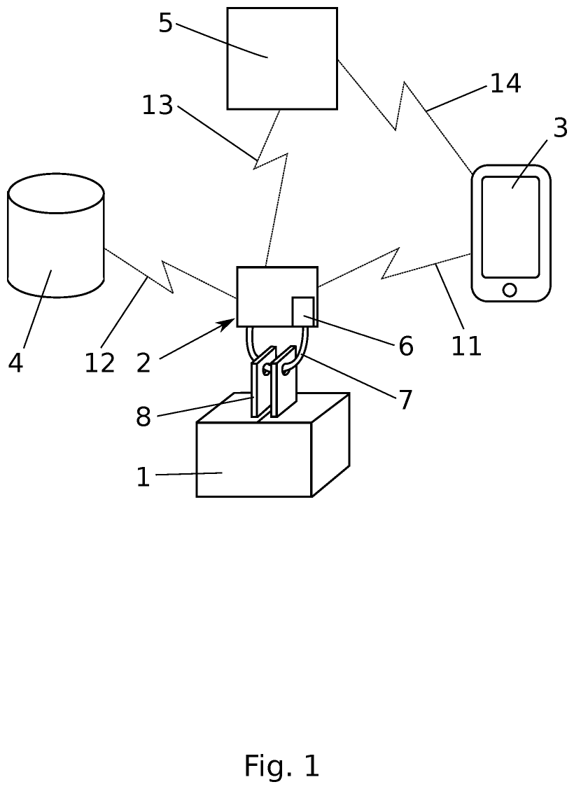

FIG. 1 schematically shows the elements involved for suspending protection of an object according to the present invention.

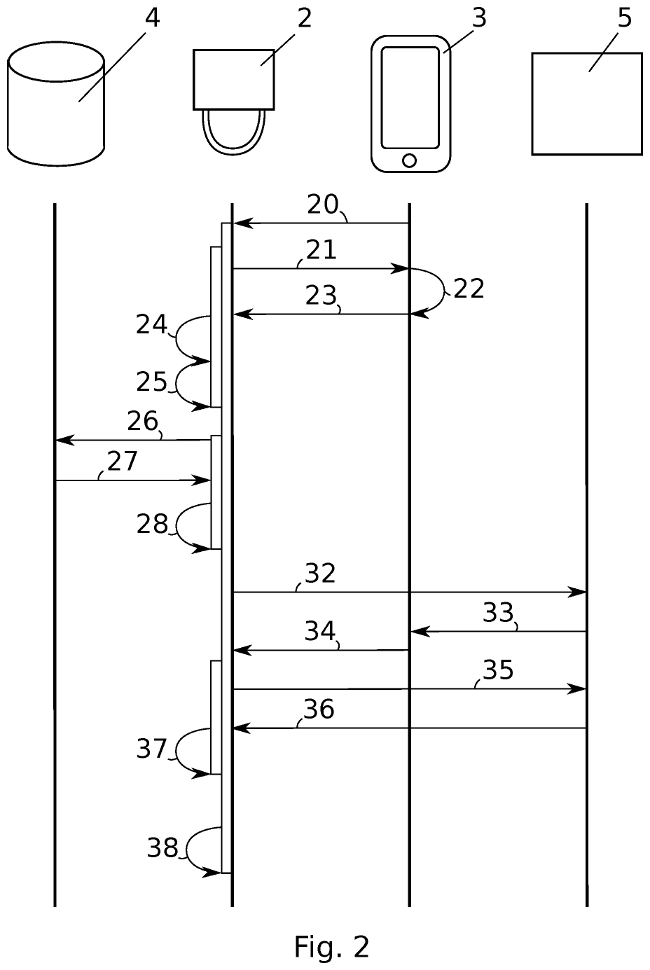

FIG. 2 shows a sequence diagram of a variant of the method for suspending protection of an object according to the present invention.

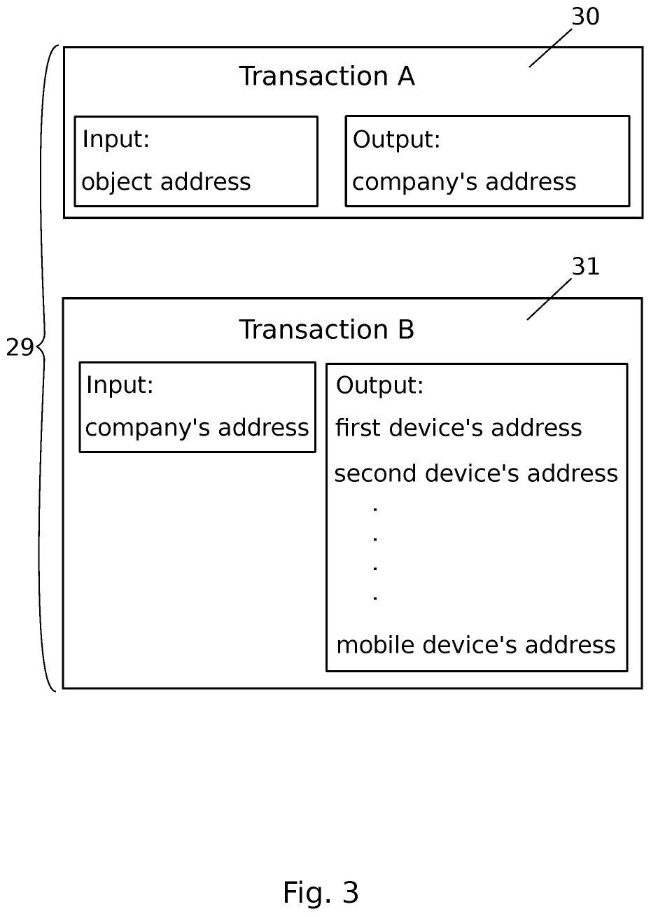

FIG. 3 schematically illustrates transactions in a transaction directory used in a variant of the method for suspending protection of an object according to the present invention.

FIG. 1 shows an object 1, which is (in particular physically) protected by a protection device 2. In the present embodiment the object 1 is a box, e.g. enclosing a product; alternatively, the object may be the product itself. The protection device 2 has a controllable actuator 6 for engaging and releasing physical protection of the object 1. To achieve the physical protection of the object 1, the protection device 2 comprises a yoke 7 to form a padlock. Alternatively, the protection device 2 does not need to achieve the physical protection of the object 1 itself, but can control the object 1 (e.g. send a control signal to the object) to suspend physical protection of the object 1. For example, the object 1 can be a car and the protection device 2 can suspend protection of the car by sending an unlock command to door locks of the car.

In the present example, the object 1 is protected in that the yoke 7 traversing mountings 8 on the object 1 is locked in a closed position by means of the protection device 2 and specifically the actuator 6. In order to suspend the physical protection of the object 1, the actuator 6 can be controlled to release the yoke 7 from its locked position and may then be removed from the mountings 8. Once the mountings 8 are released from the yoke 7, the box forming the object 1 may be opened, i.e. the object is no longer physically protected.

The protection device 2 is connected to a mobile device 3 over a first data connection 11, in particular a wireless connection, e.g. a RF connection, in particular a Bluetooth or NFC connection. Furthermore, the protection device 2 is connected to a transaction directory 4 over a second data connection 12. The transaction directory 4 is in particular an on-line public transaction directory, and the second data connection 12 is in particular a mixed, partially wireless and partially wired, data connection established via the internet. For simplicity, all data connections are illustrated as wireless connections.

The protection device 2 is further connected to an authentication entity 5 over a third data connection 13, which is in particular a mixed data connection established via the internet. Additionally, the mobile device 3 is connected to the authentication entity 5 over a fourth data connection 14, which is in particular also a mixed data connection established via the internet.

In order to explain the method of the present disclosure for suspending protection of the object 1 achieved by the protection device 2, an exemplary embodiment will be discussed in chronological order along with the sequence diagram shown in FIG. 2.

A first data connection 11 is established between the protection device 2 and the mobile device 3. The protection device 2 receives 20 via the first data connection 11 a public key from the mobile device 3. The public key may previously be stored in an internal memory of the mobile device 3, in particular together with a private key cryptographically associated with the public key. Subsequently, the protection device 2 authenticates the mobile device 3 using the public key, which in particular comprises determining if the mobile device 3 is in possession of the private key cryptographically associated with the public key. For this purpose, the protection device 2 sends 21 a random challenge to the mobile device 3 via the first data connection 11. The mobile device 3 signs 22 the random challenge using the private key and sends the signature to the protection device 2. I.e., the protection device 2 receives 23 the signature of the random challenge signed using the private key via the first data connection 11 from the mobile device 3. Subsequently, the protection device 2 verifies 24 the signature with the public key. Based on the determination that the verification 24 succeeds, the protection device 2 (successfully) authenticates 25 the mobile device 3. Alternatively, the mobile device 3 may first request a challenge from the protection device 2 and send back its public key only together with the signed challenge.

For determining that the transaction directory 4 contains a transaction associated with the public key, the protection device 2 requests 26 via the second data connection a search of transactions associated with the public key within the transaction directory 4. Upon receiving 27 a result of the search, the protection device 2 determines 28 that the search within the transaction directory 4 yields at least one transaction associated with the public key.

In particular the search and determination of a transaction associated with the public key may include determining a standing access right associated with an object address according to the following steps (not illustrated in FIG. 2). The object address is characteristic for the object 1 and is stored in an internal memory of the protection device 2. The protection device 2 requests via the second data connection 12 a search of transactions associated with the object address. In particular, the protection device 2 requests via the second data connection 12 a search of a chain of transactions, wherein each subsequent transaction in the chain of transactions is linked to a respective previous transaction in the chain of transactions by at least one output address of the previous transaction being identical to at least one input address of the subsequent transaction, wherein the subsequent transaction is chronologically after the respective previous transaction and wherein a first transaction in the chain of transactions is the last object transaction; which last object transaction is the chronologically last transaction associated with the object address. In case there is a chain of transactions linking the object address to an address associated with the public key, the protection device can determine that there is or was a standing access right associated with the public key, and therefore, with the mobile device. Furthermore, to determine if the access right was subsequently revoked, the protection device 2 determines a last output transaction in the chain of transaction, which last output transaction is the chronologically last transaction in the chain of transactions comprising at least one output address associated with the public key; and the protection device 2 determines for the public key the standing access right associated with the object address further based on a determination that there is no later input transaction, which later input transaction is chronologically after the last output transaction and which later input transaction comprises at least one input address associated with the public key.

FIG. 3 illustrates an example of a chain of transactions 29 in the transaction directory 4. “Transaction A” is a first transaction 30 in the chain of transactions 29. Its input address (or one of its input addresses) is the object address. It output address is a company's address. This transaction 29 may have been registered in the transaction directory 4 by an owner (or administrator) of the object, who is also in possession of an object private key cryptographically associated with an object private key, which is represented in the transaction 29 by the object address as input address. Registering a transaction with the object address as input address may require possession of the object private key. Therefore, as long as the object private key is indeed private, only the object's owner can register the according transaction 29, thereby granting an access right a company, whose company address is the output address of the transaction 29. The company address may again be a representation of a company public key, which is cryptographically associated with a company private key. Thus, with the company being in possession of the company private key, the company can pass the access right on by registering “Transaction B”, which comprises the company address as an input address. “Transaction B” is dated chronologically after the first transaction 29 (“Transaction A”) and is also the last output transaction 31 in the chain of transaction 29, which last output transaction 31 is the chronologically last transaction in the chain of transactions comprising at least one output address associated with the public key. One of the output addresses of the transaction 31 is the mobile device's address, thereby granting the mobile device 3 an access right. That the access right is currently standing can be determined by the first transaction 30 in the chain 29 of transaction being the chronologically last object transaction and by there not being a later input transaction, which later input transaction is chronologically after the last output transaction and which later input transaction comprises at least one input address associated with the public key.

Returning to the sequence illustrated in FIG. 2, also a third data connection 13 between the protection device 2 and an authentication entity 5 and a fourth data connection 14 between the authentication entity 5 and the mobile device 3 are established. The authentication entity 5 may authenticate itself with the protection device 2 and/or the protection device 3 may authenticate itself with the authentication entity 5 (by any means known in the prior art).

As an authentication request, the protection device 2 requires 32 via the third data connection 13 the authentication entity 5 to send the identification string to the mobile device 3 via the fourth data connection 14. The authentication request may comprise an indication of the public key. The identification string may be a one time password, in particular generated by the authentication entity 5 and in particular unique for the authentication request. Based on the authentication request, the mobile device 3 receives 33 the identification string from the authentication entity 5 via a fourth data connection 14 established between the mobile device 3 and the authentication entity 5. Subsequently, the protection device 2 receives 34 via the first data connection 11 the identification string.

Then, the protection device 2 requires 35 via the third data connection 13 a clearance of the identification string by the authentication entity 5, wherein this request in particular comprises the identification string. In case the authentication entity 5 originally provided the mobile device 3 with the identification string, the authentication entity 5 may simply check that the string received from the protection device 2 in the clearance request is the same as the original string. However, clearance can also be based on other factors and the authentication entity 5 can check the identification string received from the protection device 2 for other characteristics, also in case it did not originally provide the identification string to the mobile device 3. Subsequently, the protection device 2 receives 36 the clearance of the identification string by the authentication entity 5 and the protection device 2 determines 37 that the identification string is cleared.

Based on the Determinations
that the authentication of the mobile device is successful, and
that the search within the transaction directory yields at least one transaction associated with the public key, in particular that there is a standing access right, and
that the identification string is cleared,
the protection device 2 suspends 38 protection of the object 1, in particular controls the actuator to suspend 38 protection of the object 1. Thereby, the object 1 becomes in particular accessible and/or usable, in particular to an operator of the mobile device 3.

1. Method for suspending protection of an object achieved by a protection device, comprising the following steps:
a first data connection is established between the protection device and a mobile device;
a second data connection is established between the protection device and a transaction directory;
the protection device receives via the first data connection a public key;
the protection device requests via the second data connection a search of transactions associated with the public key within the transaction directory;
the protection device determines that the search within the transaction directory yields at least one transaction associated with the public key;
a third data connection is established between the protection device (2) and an authentication entity;
the protection device receives via the first data connection an identification string;
the protection device requires via the third data connection (13) a clearance of the identification string by the authentication entity;
the protection device determines that the identification string is cleared;
based on a determination that the search within the transaction directory yields at least one transaction and based on a determination that the identification string is cleared, the protection device suspends protection of the object.

2. Method according to claim 1, wherein the method further comprises:
the protection device determines for the public key a standing access right associated with an object address, which object address is storable in an internal memory of the protection device;
the protection device suspends protection of the object further based on a determination for the public key of the standing access right associated with the object address.

3. Method according to claim 2, wherein determining for the public key the standing access right associated with the object address comprises:
the protection device requests via the second data connection a search of transactions associated with the object address.

4. Method according to claim 3, wherein determining for the public key the standing access right associated with the object address further comprises:
the protection device determines a last object transaction, which last object transaction is the chronologically last transaction associated with the object address.

5. Method according to claim 4, wherein determining for the public key the standing access right associated with the object address further comprises:
the protection device requests via the second data connection a search of a chain of transactions, wherein each subsequent transaction in the chain of transactions is linked to a respective previous transaction in the chain of transactions by at least one output address of the previous transaction being identical to at least one input address of the subsequent transaction, wherein the subsequent transaction is chronologically after the respective previous transaction and wherein a first transaction in the chain of transactions is the last object transaction;
the protection device determines that the chain of transactions comprises at least one transaction associated with the public key;
the protection device determines for the public key the standing access right associated with the object address based on a determination that the chain of transactions comprises at least one transaction comprising at least one output address associated with the public key.

6. Method according to claim 5, wherein determining for the public key the standing access right associated with the object address further comprises:
the protection device determines a last output transaction in the chain of transaction, which last output transaction is the chronologically last transaction in the chain of transactions comprising at least one output address associated with the public key;
the protection device determines for the public key the standing access right associated with the object address further based on a determination that there is no later input transaction, which later input transaction is chronologically after the last output transaction and which later input transaction comprises at least one input address associated with the public key.

7. Method according to claim 1, wherein the method further comprises:
the protection device authenticates the mobile device using the public key;
the protection device suspends protection of the object further based on successful authentication of the mobile device.

8. Method according to claim 7, wherein authenticating the mobile device by the protection device comprises:
the protection device sends a random challenge to the mobile device via the first data connection;
the protection device receives a signature of the random challenge signed using a private key cryptographically associated with the public key via the first data connection;
the protection device verifies the signature with the public key;
based on a determination that verification succeeds, the protection device authenticates the mobile device.

9. Method according to claim 1, wherein the method further comprises:
based on an authentication request, the mobile device receives the identification string from the authentication entity via a fourth data connection established between the mobile device and the authentication entity.

10. Method according to claim 9, wherein the identification string is a one time password.

11. Method according to claim 10, wherein the one time password is unique for the authentication request.

12. Method according to claim 9, wherein the authentication request comprises:
the protection device requires via the third data connection the authentication entity to send the identification string to the mobile device via the fourth data connection.

13. Method according to claim 9, wherein the authentication request comprises:
the mobile device requires via the fourth data connection the authentication entity to send the identification string to the mobile device via the fourth data connection.

14. Method according to claim 12, wherein the request comprises an indication of the public key.

15. Method according to claim 1, wherein the method comprises:
the protection device determines that the transaction associated with the public key comprises a contract script, which evaluates at least one condition for unlocking the protection device;
the protection device executes the contract script;
the protection device determines that the contract script executes successfully and the at least one condition of the contract script is fulfilled;
the protection device suspends protection of the object further based on the determination that the contract script executes successfully.

16. Method according to claim 15, wherein executing the contract script comprises:
determining a current time;
determining that the current time is within a time interval defined in the contract script.

17. Method according to claim 1, wherein the method comprises:
the protection device requires a report transaction to be registered within the transaction directory, wherein the report transaction comprises an indication of a suspension of the physical protection of the object.

18. Method according to claim 17, wherein the method further comprises:
the protection device determines at least one physical status parameter of the object by at least one sensor of the object;
wherein the report transaction further comprises an indication of the at least one physical status parameter of the object.

19. Method according to claim 1, wherein the transaction directory is a distributed directory.

20. Method according to claim 1, wherein the first data connection is a wireless data connection.
